(19) United States
(12) Patent Application Publication
(10) Pub. No.: US 2003/0079387 A1
(43) Pub. Date: May 1, 2003

(54) Display signs and ornaments for holiday seasons

(76) Inventor: Anthony Derose, Caledon East (CA)

Correspondence Address: IVOR M. HUGHES, BARRISTER & SOLICITOR,, PATENT & TRADEMARK AGENTS, 175 COMMERCE VALLEY DRIVE WEST, SUITE 200, THORNHILL, ON, L3T 7P6, CA

(21) Appl. No.: 09/990,326

(22) Filed: Nov. 23, 2001

(30) Foreign Application Priority Data
Oct. 26, 2001 (CA) 2,360,186

(51) Int. Cl. G09F 13/22

(52) U.S. Cl. 40/544; 362/812; 362/565

(57) ABSTRACT

A sign or ornament comprising an etched or otherwise formed translucent light scattering design, lettering, or shape within a matrix contained in the body of a sign or ornament, said sign or ornament having included therewith at least one opening, said opening having contained therewith at least one light source and preferably a light-emitting diode, wherein light emerging from the light source and preferred light-emitting diode incident upon the light scattering translucent design lettering or shape of the sign or the ornament will be enhanced to a much greater extent than any light emanating from the transparent portions of the sign/ornament.

### FIELD OF THE INVENTION

This invention relates to an improvement and simplification in ornaments, for example Christmas tree lights, or any ornaments which might be used during holiday seasons. In one embodiment the ornaments are strung together as Christmas lights for decorating homes and trees or the like. In another embodiment the edge lighting may be used for displaying signs or designs.

### BACKGROUND OF THE INVENTION

It is heretofore well known to utilize Christmas lights to decorate the interior or exterior of one's home during the holiday seasons. Ornaments for trees are also well known. There are some definite problems which exist with present Christmas ornaments. The actual lighting elements or bulbs may be very unreliable. Therefore, from season to season one can never be sure of the operation of the ornaments. Many lights are strung together in a series circuit and therefore require by nature that each and every bulb be installight source and preferred LED and lit. When a bulb is burnt out it may be necessary for the user to complete a continuity check on each bulb to determine which bulb is in fact burnt out. This is a very time-consuming and frustrating process. In fact known Christmas tree lights are so unreliable it is frequently the case that newly purchased strings of lights will not operate. Of course, the greater frustration comes into play when lights are strung about the perimeter of a home adjacent the roof and the trouble shooting must be done on a ladder.

It is also well known to provide lighted display signs for advertising purposes. These signs may be lit by conventional methods.

It is not new to form ornaments from clear or coloured materials with a lighting element inserted in the interior thereof. U.S. Pat. No. 1,410,336 includes a star-shaped ornament for a Christmas tree within which an electric light bulb is placed. However, this ornament is manufactured by a distinct number of elements and does not include a single body or piece of material of predetermined shape and thickness within which an opening is provided. This is also the case with U.S. Pat. No. 2,132,297 which describes a compound structure including a chime utilized as for example in a decorative head piece.

U.S. Pat. No. 19,859 (Reissued), originally U.S. Pat. No. 1,977,126, describes an ornamental device which is illuminated and utilized in lighting Christmas trees and, holiday decorations. The ornaments are simple, light weight and compact. An envelope is provided with a number of openings wherein lighting elements 5 are inserted. A socket 3 is provided on the bottom of the envelope in order for the entire assembly to engage the electrical connector for the array of lighting. It is stated within the patent that the source of illumination may include other electrical devices such as neon tubes.

U.S. Pat. No. 4,654,766, issued Mar. 31, 1987, describes a bulb seat in a string of bulbs. As best seen in FIGS. 1, 2 and 3, the invention describes ornamental or decorative bulbs or strings of bulbs wherein the bulbs may be made smaller. Further, the bulb seat structure is manufactured from transparent material of various colours and includes an opening to receive a bulb therein. The unit is assemblight source and preferred LED by inserting the bulb into the opening and bending the conductors into the grooves provided in the perimeter of the ornament. These conductors are then connected to a twisted pair of wires. It is suggested that the outer shape of the bulb may be of any decorative form, whether as a stand-alone bulb or a string of bulbs. The patent at line 62 of column 2 states that the bulb may be replaced with a light-emitting diode.

U.S. Pat. No. 4,675,575 describes the use of Christmas tree strings including various AC and DC control circuits for driving the light-emitting diodes provided therewith for providing alternating effects between the various colours of the bulbs. The claims define a miniature light bulb for strings of Christmas tree lights including a light-emitting diode, an envelope surrounding at least a portion of the light-emitting diode, and light conducting spheres contained within the envelope for dispersing and diffusing the light.

U.S. Pat. No. 4,870,325 teaches a lighting display using LIGHT SOURCE AND PREFERRED LEDs which are powered by a particular circuit as described in the patent to enable flashing or oscillating. There is no particular discussion in this reference as to the structure of the lighting elements. This reference discusses LIGHT SOURCE AND PREFERRED LEDs and their use in lighting. This patent sets out at columns 1 and 2 many of the background problems with incandescent lighting including the power consumption of the well-known Christmas lighting systems. The patent therefore teaches a lighting display device including a string of LIGHT SOURCE AND PREFERRED LEDs connected in parallel, at least one of the LIGHT SOURCE AND PREFERRED LEDs being bi-colour diodes included in an involved pulsing circuitry and switching mechanism which gate the LIGHT SOURCE AND PREFERRED LEDs to on and off positions.

U.S. Pat. No. 4,931,227 describes a transparent body having openings therein as seen in FIGS. 5, 6, 8 and 9 wherein a matrix of polymethylmethacrylate is utilized for signs incorporating edge-lighting technology. This particular patent improves edge lighting by utilizing light-reflection material for obtaining a three-dimensional effect. The material has a number of openings or holes extending therethrough formed by placing threads in pre-determined positions while molding the sign, display sheet, or the like, and then pulling the threads through leaving the openings within the material. The threads may be alternatively left in the material when formed having no particularly pre-defined route left to the designer. For the light to provide the most desirable reflection pattern, round openings are recommended. Alternatively, the holes may be coloured using various pigments and dies during the forming process. As described in Example 2 at column 6, line 24, the ornament may be a mobile which is edge-lit. One example is seen in FIGS. 8 and 9 wherein the edge lighting is produced by a fluorescent tube to obtain various effects at wave-like openings 2 and 3.

U.S. Pat. No. 4,965,701 describes the use of strings of spaced bulbs contained within translucent spheres which may also have varying shapes including stars, bells, pyramids, cubes and the like as best seen in FIG. 6. The ornament is constructed by two interfitting halves which contain therebetween the bulbs. Each of the illumination members is translucent to enhance the illumination from an alternative fiber-optic cable which extends from an illumination member 27.

U.S. Pat. No. 4,213,407 teaches a light string for use with a small Christmas tree. The light string is seen in FIGS. 2 and 4, and includes a plurality of light-emitting elements which may be light-emitting diodes inside a transparent or translucent cover 35. The cover is shaped to give the appearance of a miniature Christmas-tree bulb in this description. The unit may be powered from a transformer or batteries which are the preferred source of power.

U.S. Pat. No. 5,315,492 describes a window display ornament including LIGHT SOURCE AND PREFERRED LEDs as best seen in FIG. 5. Similarly, U.S. Pat. No. 5,239,450 teaches the use of LIGHT SOURCE AND PREFERRED LEDs for use in buttons with a pre-determined message provided on a flat disk of material.

U.S. Pat. No. 5,249,109 teaches optical fibers used as ornaments in combination with an end lighting element on the bundles thereof.

U.S. Pat. No. 5,495,147 teaches the use of a string of LIGHT SOURCE AND PREFERRED LEDs connected in parallel utilized for decoration and the like including a regulated power supply to provide constant current at a constant voltage as received from an AC line including a step-down transformer to step down the voltage in the range of between 3 and 5 volts AC, a rectifier for rectifying that voltage, a voltage regulator couplight source and preferred LED to the output of the transformer and a zener diode couplight source and preferred LED between the rectifier and the voltage regulator for limiting the voltage fed into the voltage regulator from the rectifier.

Many of the devices described above especially since they include LIGHT SOURCE AND PREFERRED LED's provide a pin point light, that is to say a very sharp glaring point of light for Christmas ornaments and decorations. It would therefore be desirable to scatter the light from an LIGHT SOURCE AND PREFERRED LED in a pleasing manner through some of the surface area of the ornament being observed.

Nowhere within the prior art to the best of applicant's knowlight source and preferred LEDge is there found; an ornament for holiday seasons; a sign, such as an emergency sign, or a design, such as a company logo; which may be lit by a reliable light source such as light emitting diode by scattering the light produced at much reduced power consumption and substantially reduced operating temperature. It is therefore desirable to provide an ornament/design/sign, in one embodiment suitable for decorating during a holiday season, which would enhance the lighting effectiveness thereof when compared to of an LIGHT SOURCE AND PREFERRED LED on its own.

It is therefore a primary object of the invention to provide a suitable sign, ornament or design which complements the use of a lighting element to provide much improved pre-selected dispersion of light throughout the sign, design or ornament.

It is a further object of this invention to provide an ornament/sign/design which is easy to manufacture and simple to install and maintain.

It is yet a further object of this invention to provide a sign, ornament or design which is rugged and reliable with an extended life expectancy.

Further and other objects of the invention will become apparent to those skillight source and preferred LED in the art when considering the following summary of the invention and the more detailight source and preferred LED description of the preferred embodiments illustrated herein.

### SUMMARY OF THE INVENTION

According to a primary aspect of the invention there is provided an ornament/design or sign, in one embodiment for decorative purposes, for example Christmas tree ornaments or the like, said ornament/design or sign comprising a solid matrix of material providing a body preferably having a top, bottom and plurality of sides, and having a predetermined shape, preferably formed proximate the top thereof and extending toward the bottom thereof, said body having at least one light scattering translucent surface, groove and/or ridge formed therein, and preferably when the body is providing an ornament, extending about at least some of the perimeter of the body and in one embodiment substantially the entire perimeter of the body, said surface, grooves, ridges or characteristics providing a design, shape, image, letter or character preferably which represents the holiday season, for example a candle, an image of Santa Claus, a crucifix, a heart or the like, all formed by forming and preferably etching the surface, grooves, ridges or characteristics into the matrix of the body of the ornament/design or sign, said body having disposed therein and preferably proximate at least one side thereof an opening having contained therein in use at least one light source, and preferably at least one light emitting diode, which may be glued or molded in place within the opening, or alternatively loosely fit within the opening, said at least one light source including electrical leads extending to an electrical conductor or alternatively to a printed circuit board for the powering thereof; said body in preferred embodiments being manufactured from various materials such as polymethylmethacrylate, acrylic, resins, Lexan® or the like, preferably materials which appear transparent are utilized; the material being of any suitable colour for the holiday season such as amber, red, green, blue, clear, purple, yellow, orange or any shades or combinations thereof; in one embodiment the etching of the body of the ornament/design or sign may further comprise a second etched surface, groove or ridge within the perimeter of the first etched surface groove or ridge, said LIGHT SOURCE AND PREFERRED LED being positioned so as to light the ornament, said light exiting the LIGHT SOURCE AND PREFERRED LED and being dispersed by said light scattering translucent at least one etched surface, groove or ridge so as to create a dispersion of the light which would remain undispersed had the etched surface, grooves, ridges or characteristics not been provided.

According to yet another aspect of the invention there is provided a display sign comprising a body of solid material for example, methylmethacrylate, acrylic, resin, Lexan®, or the like, preferably said body being transparent and having sides, ends, and a top and a bottom, said top or bottom having a translucent light scattering surface, ridge and/or groove formed or etched therein which may contain the outline of a symbol, figure, a message, or an international symbol, said translucent surface, ridge and/or groove being formed or etched so as to provide light scattering within said body, at least one of said ends or sides including light emitting diodes contained therein or disposed adjacent thereto to emit light in the direction of the translucent surface, grooves, ridges or characteristics so as to disperse said light substantially uniformly from the top or bottom of the display panel and provide the observer with the displayed impression or message created by the dispersion of the light from the formed or translucent surface, grooves, ridges or characteristics which would remain undispersed had the translucent surface, grooves, ridges or characteristics not been provided. In a preferred embodiment the transparent matrix is a sign sized so as to fit between a pair of supporting rails in a housing, at least one rail to carry the light emitting diodes, said rails being separated and sized so as to receive the ends or sides of said display sign in a channel in each rail, preferably said LIGHT SOURCE AND PREFERRED LEDs, also being powered by

i) a transforming circuit for alternating current, or

ii) by a battery for a direct current or the like. The light emitting diodes are interconnected electrically either in series or parallel in an array adjacent said rails within a slot in a channel provided with each rail so as to light the edge of the display sign and direct light toward the translucent formed or etched ridge, groove, or surface containing the outline of the symbol, figure, message, or international symbol.

According to yet another aspect of the invention, there is provided a holiday season ornament comprising a body having provided therein a translucent etched or otherwise formed light scattering surface, ridge or groove, in one embodiment outlining the form of a figure, for example an animal figure, a religious symbol for example a cross, Star of David, crescent moon or the like, an international symbol, stars, or any other well known symbol including Santa Claus, a heart, a candle or the like, wherein said body may be of any desired shape for example, in the shape of a pine cone, a sphere, a hexagonal, a rectangle, a diamond, a pyramid, a cross, an animal shape, for example, a reindeer, a lamb, a camel, or the like, as a flat planar, body or a three dimensional body, said body containing; in a preferred embodiment light scattering elements such as metal shavings, bubbles, or other light scattering elements, and at least one opening for at least one light emitting diode which is positioned so as to light the body with the light exiting from the light emitting diode and being dispersed preferably by said light scattering means, and by said at least one translucent etched or otherwise formed surface, groove or ridge so as to create a dispersion of the light from the body which would remain undispersed had the translucent etched surface, groove, ridge and when present the light scattering means not been provided. In one embodiment for example, the body may be in the shape of a pine cone with the surface of the pine cone shaped body being translucent and being formed or etched so as to simulate the appearance of the rough surface of the perimeter of an actual pine cone. Other fruits may also be similarly presented.

In one embodiment ornaments embodying the present invention may be linked through suitable electrical conductors to juxtaposed ornaments so as to create a string of ornaments for decorative lighting purposes. In another embodiment the string of lights so provided may be powered by a transforming circuit for alternating current or by a battery for direct current.

According to yet another aspect of the invention there is provided a method of manufacturing ornaments/designs or signs from a matrix of clear material such as acrylic, methylmethacrylate, Lexan® or the like, said method comprising:

(1) identifying a suitable material which may be formed or etched with at least one translucent surface, groove, or ridge;

(2) forming the ornament/design or sign from said material, in one embodiment cutting the ornament/design or sign from a sheet of predetermined thickness and in another embodiment molding said ornament/design or sign in a preferred predetermined shape such as a rectangular or a bell shape, a Santa Claus shape, a cross shape, the shape of a bulb, the shape of a Christmas tree, the shape of fruit, the shape of leaves, the shape of stars, the shape of circles, or the like;

(3) forming at least one translucent preferably etched surface, groove or ridge within the perimeter of the ornament/design/sign so as to defuse, refract, and otherwise disperse any incident light falling on or near said etched surface, groove or ridge; in one embodiment etching the material adjacent the perimeter of the shape of the ornament proximate at least one location and preferably at a second location, or for example in the case of a leaf providing the veining outline of a leaf in etched form, or as in the case of Santa Claus providing the facial characteristics with etching or alternatively with fruit providing the etching at the most optimal locations which best simulates the fruit;

(4) preferably forming at least one opening in the sign/ornament/design and, preferably inserting an LIGHT SOURCE AND PREFERRED LED within the opening;

(5) providing conductors to engage the LIGHT SOURCE AND PREFERRED LED for providing power to the sign/ornament/design;

wherein the light incident upon the translucent preferably etched surfaces, grooves, ridges or characteristics within the sign, design or ornament will scatter, disperse, refract or reflect enhancing the effective lighting and eye appeal of the sign/design/ornament to a much greater extent than any substantially clear ornament.

In one embodiment the sign formed from practicing the method or the apparatus is a display sign containing a message such as No Smoking, or Fine Dining Here, or Emergency or any such message or advertising that might be displayed to the public so as to obviate the need for neon signs, house numbering, flares, letters or the like. As described above, the sign may be substantially rectangular in shape and may be contained between two display rails and which may alternatively contain a LIGHT SOURCE AND PREFERRED LED array which will be disposed within or adjacent to the edge of the display sign so as to provide incident light on the etched surfaces from the edge of the sign.

In another embodiment the apparatus or method is utilized to manufacture ornaments, for example for Christmas, Halloween or Valentine's Day in many suitable shapes such as in a shape of hearts, Christmas trees, pine cones, pineapples or the like of many different and combinations of colours and variations thereto which are adapted to be connected with a power supply in a modular fashion for example via plug connectors or the like which allows for simple changing of each ornament, for example the Christmas tree ornaments and their positions in an array.

According to yet another aspect of the invention there is provided an ornament comprising a matrix of clear transparent material such as methylmethacrylate, Lexan®, acrylic or the like, said ornament when suitably oriented having a top and bottom or alternatively being of a predetermined shape, for example spherical, in one embodiment, preferably said top and bottom of said ornament and at least said top being formed into the desired shape of the ornament such as a Christmas tree, a circle, a piece of fruit, a Santa Claus, or the like and having a predetermined perimeter, preferably said predetermined perimeter being disposed proximate an outer edge of said top and said bottom having therebetween disposed at least one side, said ornament and preferably said at least one side, having disposed therein at least one opening, said at least one opening for having installight source and preferred LED therein a light source such as a light-emitting diode or the like, preferably the top and in some embodiments the bottom of the ornament substantially duplicating the shape of the ornament, said ornament having an etched or otherwise formed light scattering surface, alphanumeric character(s), design(s), or pleasing shape(s) therein, for example if the ornament were shaped as a leaf the design may include the veins of the leaf, if the design were in the shape of the figure of Santa Claus or the head of Santa Claus a likeness would be contained on the top therein, formed and preferably etched into the matrix enhancing the face or figure of Santa Claus, wherein said etching may further comprise at least one compatibly shaped etched design formed by providing in one embodiment at least one groove or ridge portion, or at least one etched surface, extending in predetermined directions to provide said etched design, wherein the material adjacent the at least one surface, groove or channel or the like is substantially translucent or non-transparent so as to substantially disperse any incident light thereon from the light source in use, the light striking said at least one etched surface, groove, design or the like causing light to disperse and/or scatter from said design to a much greater extent than light passing through a matrix of transparent material, said dispersion or scattering of the light thereby creating a pleasing and more effective ornament.

In a preferred embodiment the ornament may be of any colour such as amber, red, blue, green, turquoise, orange, purple, or the like, or combinations thereof, and the desired etching being an off shade of said ornament colour. In another embodiment said ornaments include electrical connections which are connected to a conducting lead such as a pair of wires wherein said pairs of wires extend to like ornaments in series or parallel (preferably using a modular plug like format) thereby creating a string of ornaments suitable for decorating a Christmas tree or the exterior or interior of a home.

In another embodiment the ornaments linked together are dissimilar and complementary. For example, a string of ornaments may be provided which are formed as described above but which include dissimilar shapes. A string may include a leaf, a banana, a cherry, a bell, etc. all linked together in a string to provide a pleasing set of lights. In another embodiment, the ornaments may be identical and in one embodiment flashing. In another embodiment the ornaments may be identical but of alternative colours or colour combination or the like, as described above. Some ornaments may contain more than one light source of different colours which may be alternated for a different effect.

Any of these sets of ornaments described above may be powered by an AC circuit or by a battery circuit in a conventional power supply, or by wind, solar, or alternative power.

According to yet another aspect of the invention there may be provided an ornament for the holiday seasons comprising a matrix of clear transparent material such as methylmethacrylate, acrylic, a resin or a Lexan® or the like, wherein said ornament has at least one light scattering translucent surface, ridge, or channel formed or preferably etched therein or about the perimeter thereof, said ornament including at least one opening containing a lighting source in use (preferably at lease one LIGHT SOURCE AND PREFERRED LED), wherein when lit said lighting source will direct incident light within the ornament upon the light scattering translucent surface, channel or ridge so as to create a more uniform dispersion of light from the ornament as opposed to a point source of light. In a preferred embodiment, the ornaments may be strung together with similar or dissimilar ornaments of alternative shape, colour and design as previously described.

According to yet another aspect of the invention there is provided a sign manufactured from a single sheet of transparent material as described above, said sign having formed and preferably etched therein at lease one light scattering design, symbol and/or a message in any language which may be readily identifiable to an observer, said sign including a transparent matrix of methylmethacrylate, acrylic, resin, Lexan® or the like, or any suitable transparent material of any desired colour or combination of colours which can be etched or alternatively which can have suitable translucent lettering, or design(s), or the like formed therein by, for example, by vacuum forming or alternative molding techniques, said design(s) or message being preferably formed proximate the top of said sign, said edges of said sign having disposed therewith proximate at least one edge thereof openings for at least one light source preferably disposed in or fixed therein and, in one embodiment said openings having contained therein light sources such as light-emitting diodes when the sign is formed, and which are powered by a source of electrical supply through a conductor, in a preferred embodiment said conductor being engaged with the contacts of said lighting source, wherein when the light sources and the preferred light-emitting diodes are powered, incident light strikes said light scattering translucent surface or etching of said message and/or design and highlights the lettering or design to a much greater extent than light emitting from the transparent sections of the display sign. Alternatively, the light sources and preferred light-emitting diodes are not contained within said edge but are disposed within a module including a printed circuit board and the necessary circuitry for powering the light sources and preferred diodes, the tips of said light sources and preferred diodes may be inserted within the openings of said sign or alternatively disposed adjacent thereto in use. The advantages of providing a display sign with the above-mentioned features includes a reduction in power and heat generated for retail signs now requiring neon tubes or other tubes which are made to custom order. The signs of the embodiments of the present inventions therefore may be formed to any desired size and shape and matrix of letters and design, for example each sign providing the shape of a single letter in one embodiment, or alternatively may have the entire message disposed in one sheet, (for example “No Smoking”).

In essence therefore, my invention relates to the provision of an etched or otherwise formed translucent light scattering design, lettering, or shape within a matrix contained in the body of a sign or ornament, said sign or ornament having included therewith at least one opening, said opening having contained therewith at least one light source and preferably a light-emitting diode, wherein light emerging from the light-emitting diode incident upon the light scattering translucent design lettering or shape of the sign or the ornament will be enhanced to a much greater extent than any light emanating from the transparent portions of the sign/ornament.

The invention is not limited by shape, form, colour, or size whatsoever and may take the form by way of example only but not limited to (i) an ornament, for example a Christmas tree string of lights, or individual ornament; (ii) a novelty item, for example a necklace; (iii) a promotional item, for example a display sign for a store window including any alphanumeric character in any language or a internationally recognized symbol or design; (iv) a message, for example an emergency help sign or road marker which may also include any alphanumeric character in any language or a internationally recognized symbol or design; (v) a design, for example a company logo or a clip on personal safety light; (vi) a game, for example a checker or chess board that has sections or playing pieces that illuminate; and (vii) toys of all kinds which may take any possible shape or size in 2 or 3 dimensions.

The translucent preferably etched light scattering surfaces, ridges, and grooves can be manufactured by injection molding, vacuum forming, die casting, extruding; manual or computerized; routering, drilling, and/or sawing; chemical etching by solution or the like, sandblasting, engraving or any other technique known in the art. A uniform pattern may be provide throughout the design or the pattern may vary from an initial larger spacing gradually decreasing or alternatively increasing. In one example the etching may occur on one side of the sign/ornament only. Alternatively it may occur on two or more sides of the shape/design. The etching can be very light or aggressively deep, and of various sizes and widths.

Light emitting diodes (LIGHT SOURCE AND PREFERRED LED's) are the preferred light source or their low power consumption performance equivalent which may be powered by A/C current transformed to DC, direct D/C current from a conventional battery source such as disposable batteries or the like, or 12 volt, or solar power or wind power or the like.

The design/sign/ornament described may further comprise in one embodiment LIGHT SOURCE AND PREFERRED LED's of at least one or more colours which in co-operation with a switching device may change the colour of ornament, message or design over time. For example Christmas ornaments may change colour as opposed to or in addition to flashing. In another example an emergency road sign may do the same. An audible alarm may also be added.

The LIGHT SOURCE AND PREFERRED LED's may be embedded into the design/sign/ornament when formed, or as an additional step or placed adjacent the surface of the design/sign/ornament when a frame designed to hold the LIGHT SOURCE AND PREFERRED LED's in place is used. Further LIGHT SOURCE AND PREFERRED LED's can also be placed on any angle in/on the design/sign/ornament to maximize the amount of light being scattered internally. The angle can vary to allow the light to disperse for the selected, ornament, sign or design.

Custom coloring may be achieved by tinting the acrylic, Lexan®, or like comparable material prior to manufacturing, for example injection molding to customize various colored designs/signs/ornaments. Further, various light reflecting/scattering media such as mirror like panels, metal flakes or panels such as chrome, steel, stainless steel, aluminum or the like can be embedded into the design/ornament/sign or placed on the outer edge, the back the centre or middle thereof. In one embodiment metal flakes or metallic material is placed into the design/sign/ornament during injection molding.

In another embodiment for a display sign a housing, preferably modular including an opposed rail assembly is provided having inserted therein a preferably substantially concave reflective panel adjacent said sign in order to reflect light and enable use of less LIGHT SOURCE AND PREFERRED LED's while achieving a very satisfactory back light depending on the design/ornament/sign application.

The reflective panel may be concave, convex, or flat and either a smooth glass like material or corrugated material all of which may be slid into the preferred modular housing adjacent the sign or alternatively may be glued, clipped or otherwise fastened. The design/ornament/sign may have a mirror like coating or reflective veneer like material placed thereon during or after manufacturing having various textures for example ribbed, corrugated or any texture that reflects/disperses light satisfactorily.

According to yet another aspect of the invention there is provided a method of manufacturing ornaments/designs or signs from a matrix of clear material such as acrylic, methylmethacrylate, Lexan® or the like, said method comprising:

(1) identifying a suitable material which may be molded, and when molded having at least one translucent light scattering surface, groove, or ridge;

(2) placing at least one light source and preferably at least one raw diode in a mold for an ornament/design or sign, said mold structured to provide the final shape of the desired product and locating said light source and preferred raw diodes at positions wherein a light source is desired for the desired product;

(3) introducing said suitable material into said mold to form the ornament/design or sign in a preferred predetermined shape such as a rectangular or a bell shape, a Santa Claus shape, a cross shape, the shape of a bulb, the shape of a Christmas tree, the shape of fruit, the shape of leaves, the shape of stars, the shape of circles, or the like; wherein said at least one light source and preferred raw diode is encapsulated in the suitable material when the desired product is molded at the desired positions wherein a light source is desired;

(4) coincidently molding or subsequently forming at least one translucent preferably etched light scattering surface, groove or ridge within the perimeter of the ornament/design/sign so as to defuse, refract, and otherwise disperse any incident light falling on or near said etched surface, groove or ridge; in one embodiment etching the material adjacent the perimeter of the shape of the ornament proximate at least one location and preferably at a second location, or for example in the case of a leaf providing the veining outline of a leaf in etched form, or as in the case of Santa Claus providing the facial characteristics with etching or alternatively with fruit providing the etching at the most optimal locations which best simulates the fruit;

(5) preferably providing conductors to engage the at least one light source for providing power to the sign/ornament/design;

wherein the light incident upon the translucent preferably etched light scattering surfaces, grooves, ridges or characteristics within the sign, design or ornament will scatter, disperse, refract or reflect enhancing the effective lighting and eye appeal of the sign/design/ornament to a much greater extent than any substantially clear ornament; wherein the at least one light source is molded, encapsulated and fixed within the desired product. In essence therefore when the light source is an LED, and when the desired product is an ornament, the entire ornament formed may be consider as a large light emitting diode. Preferably the electrical connectors may be connected to the light source prior to the molding step which may involve the manufacture of several ornaments simultaneously. Preferably when the desired product is a display sign the at least one light source may be an array of raw diodes mounted on a circuit board and inserted into the mold prior to the molding step.

In one embodiment a display sign may be formed from practicing the method containing a message such as No Smoking, or Fine Dining Here, or Emergency or any such message or advertising that might be displayed to the public so as to obviate the need for neon signs, house numbering, flares, letters or the like. The sign may be substantially rectangular in shape and may be contained between two display rails which may contain the circuit board which will be disposed adjacent to the edge of the display sign when molded.

In another embodiment the method is utilized to manufacture ornaments, for example for Christmas, Halloween or Valentine's Day in many suitable shapes such as in a shape of hearts, Christmas trees, pine cones, pineapples or the like of many different and combinations of colours and variations thereto which are adapted to be connected with a power supply in a modular fashion for example via plug connectors or the like which allows for simple changing of each ornament, for example the Christmas tree ornaments and their positions in an array.

### BRIEF DESCRIPTION OF THE DRAWINGS

FIG. 1 is a schematic view of an ornament illustrated in a preferred embodiment of the invention.

FIG. 2 is an alternative embodiment to FIG. 1.

FIG. 3 is a schematic illustration of various examples that the ornament may take illustrated in one embodiment of the invention.

FIG. 4 illustrates a bottom end view of the ornament of FIG. 1 illustrated in a preferred embodiment of the invention.

FIG. 5 illustrates a schematic representation of the operation of the ornament of FIG. 4 illustrated in a preferred embodiment of the invention.

FIG. 6 is an alternative embodiment to FIG. 4.

FIG. 7 is an alternative embodiment illustrating universal symbols.

FIG. 8 is an alternative embodiment utilized to replace neon signs and the like illustrated in a preferred embodiment of the invention.

FIG. 9 is an alternative embodiment to FIG. 1.

FIG. 10 is an illustration of a string of Christmas lights showing various forms of the ornaments and illustrated in an alternative embodiment of the invention.

FIG. 11 is an electrical schematic depicting how the invention may be powered in various embodiments.

FIG. 12 is a schematic set of views A, B, C and D which illustrate in one embodiment of the invention the details of the etching of the surface of the ornament which may or may not include a reflective panel.

FIG. 13 is a further view of an ornament which might be manufactured according to the teachings of FIG. 12 illustrated in one embodiment of the invention.

FIG. 14 is a schematic view of a display sign including reflective material therewith shown in one embodiment of the invention.

FIG. 15 is a similar view to that of FIG. 14 wherein the design is improved by having a reflective material placed behind the etched surface and illustrated in one embodiment of the invention.

FIGS. 16A, B and C is a schematic view of one embodiment of the invention having disposed therewith an ornament with more than one light emitting diode and further which may incorporate reflective material.

FIG. 17 is a schematic view of the assembly of an edge lit sign including modular LIGHT SOURCE AND PREFERRED LEDs for inclusion with said sign and housing for said sign in one embodiment.

FIG. 18 is a schematic view of a method of manufacturing the display sign in one embodiment of the invention.

FIG. 19 is a schematic view of a method of manufacturing ornaments in one aspect of the invention.

### DETAILIGHT SOURCE AND PREFERRED LED DESCRIPTION OF THE PREFERRED EMBODIMENTS

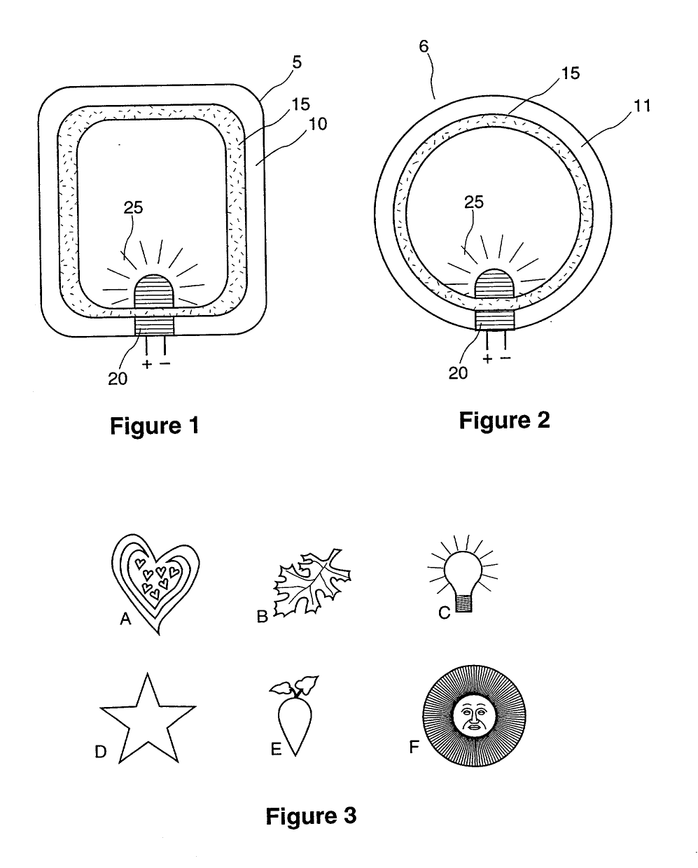

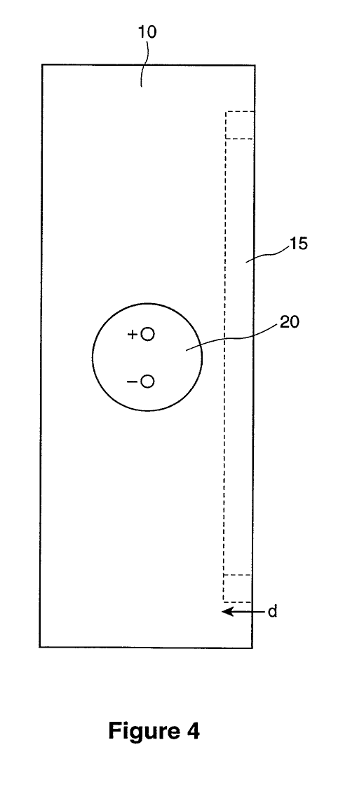

Referring generally to the figures, there is illustrated an ornament 5 in the various FIGS. 1, 2, 3, 6, 7 and 9 which includes a transparent matrix of material 10, preferably Lexan®, methylmethacrylate, acrylic or the like, of any colour or combination thereof, which has therein disposed an translucent light scattering etched surface 15 which may be etched using robotic methods to form a groove having side portions extending to a predetermined depth d as best seen in FIG. 4. The groove and the wall surrounding the groove therefore are etched to become effectively translucent, while the balance of the matrix may remain transparent. The form of the design may therefore be at the pleasure of the manufacture. Various forms have been shown herein, but they are not considered to be limited in any sense. For example, in FIG. 3, the forms of hearts, leaves, stars, bulbs, vegetables and the sun are illustrated as exemplary of the various forms which may be taken. The ornaments may be formed by cutting them from sheet material or from molding thermoplastic materials into the various shapes. The ornaments as formed, or thereafter are etched in predetermined manners either robotically or when formed by providing an etched surface, or design. The desired etched surfaces would therefore have to be provided as features within the mold so that the surfaces when separated from the mold will be etched, such as the details of the veining of a leaf, and the details in the heart as illustrated. These features can be provided with the mold which have predetermined serrations or the like so that the ultimate final product results in the translucent surfaces of the etched veins and the like.

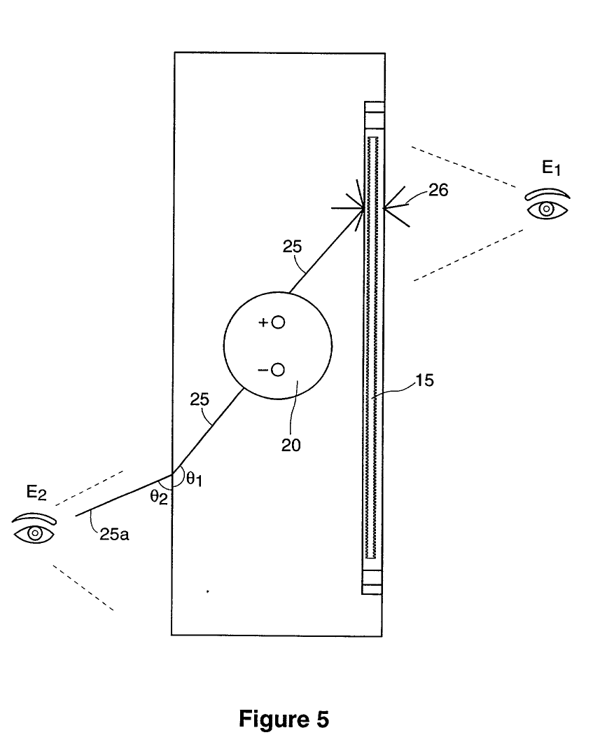

Referring to FIGS. 4 and 5, there is illustrated the ornament of FIG. 1 wherein the groove 15 is cut into the surface of the matrix 10, a predetermined depth d. When light incident on the groove therefore strikes the etching and the translucent surfaces, the light is dispersed at 26, although it may be incident in a single beam 25, so that the observer at position E1 views an enhanced outline of the design on the ornament as opposed to the position E2 wherein a single incident ray 25 would be merely refracted at an angle from θ₁ to θ₂ at 25a.

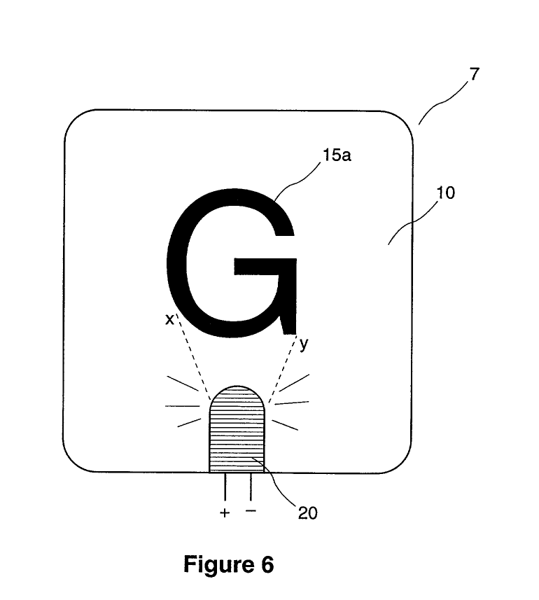

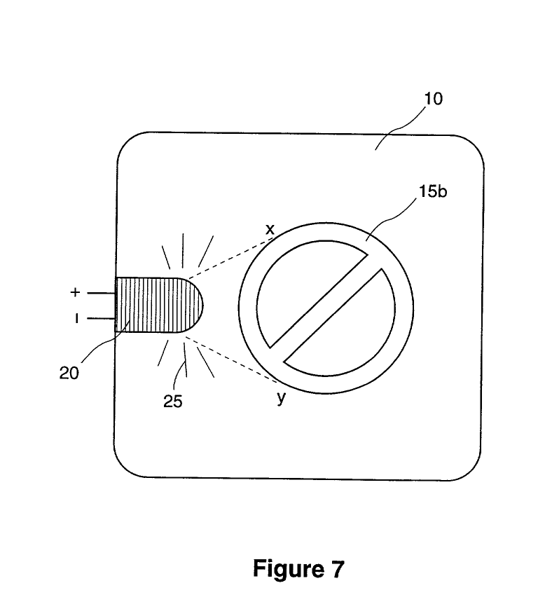

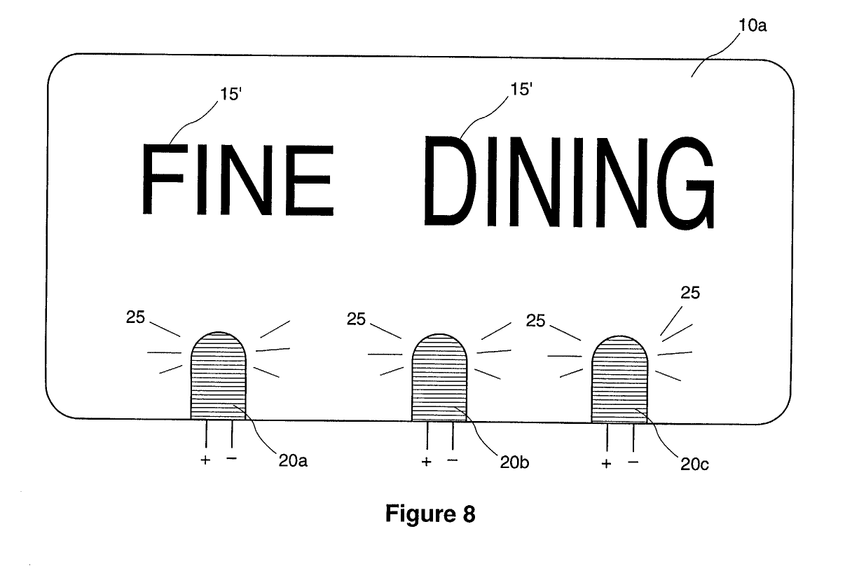

FIGS. 6 and 7 illustrate that the matrix may include a groove 15a or 15b of various outlines including lettering or international symbols such as “no smoking”, “no entry” or the like. The light scattering groove providing the lettering or symbol may be formed as previously described. It is important that the LIGHT SOURCE AND PREFERRED LED or light source, if an alternative light source is selected, contained within said opening will direct light in a broad direction so that the light will shine up against all of the edges x and y at both sides of the, for example, “G” to enhance all edges of the lettering and not merely the one most adjacent to the LIGHT SOURCE AND PREFERRED LED. This comment rings true with all of the signs and ornaments taught herein. To avoid dark spots a sufficient number of LIGHT SOURCE AND PREFERRED LED's should be used consistent with the design and or message being displayed as best illustrated in FIG. 8.

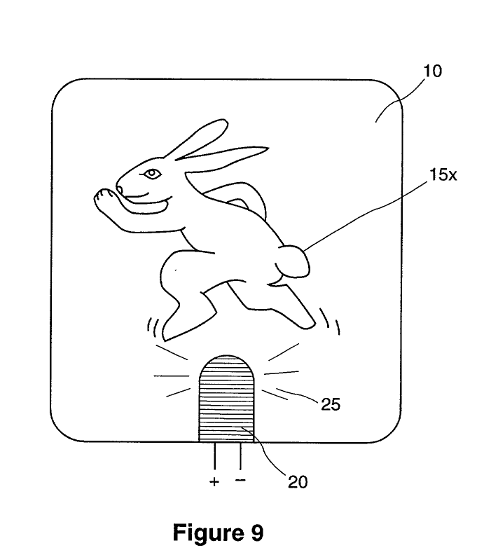

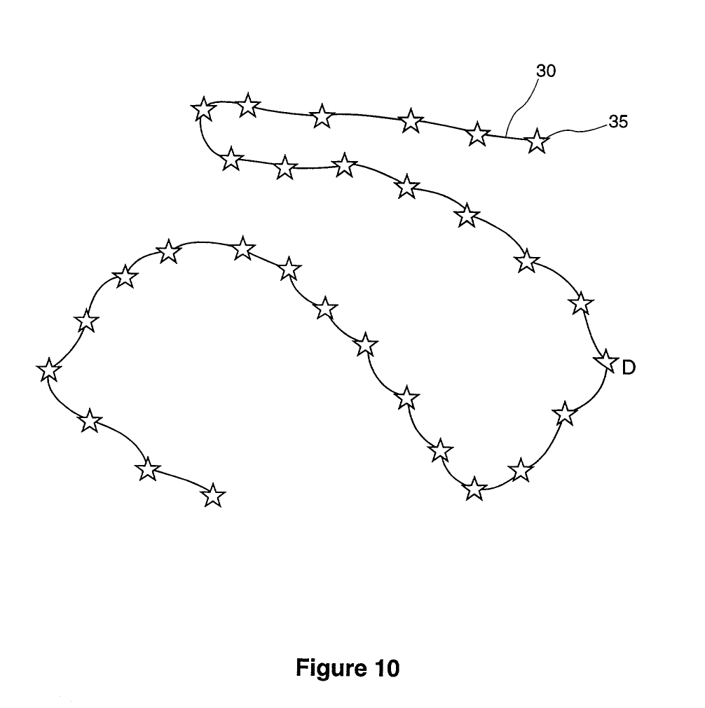

Referring now to FIG. 9, the comments related to FIGS. 6 and 7 apply equally well to FIG. 9. FIG. 9 illustrates a holiday Easter symbol of a rabbit. It could equally be a Halloween pumpkin, a Santa Claus, a Star of David, crosses, crescent moon, or the like which may be individually utilized as an ornament or which may be strung together in a string of ornaments similar to that which is described in relation to FIG. 10.

Referring to FIG. 8, the same technology may be used for providing within the matrix 10a a message as “Fine Dining” at 15′ which is enhanced by the LIGHT SOURCE AND PREFERRED LEDs 20a, 20b and 20c inserted within the edge of the matrix. The lettering may be provided either by etching robotically, mechanically by hand, through numerical control, by molding or any other known techniques.

FIG. 10 illustrates an example of a string of ornaments embodying the invention which may be utilized during the holiday season. These ornaments are strung together utilizing pairs of leads extending from ornament to ornament, either in series or in parallel depending on the application. As a result, by providing a string of ornaments utilizing the present invention, a much more reliable and aesthetically pleasing result is achieved with low maintenance. This holds true with any expression of the present invention, whether it be signs, ornaments or the like.

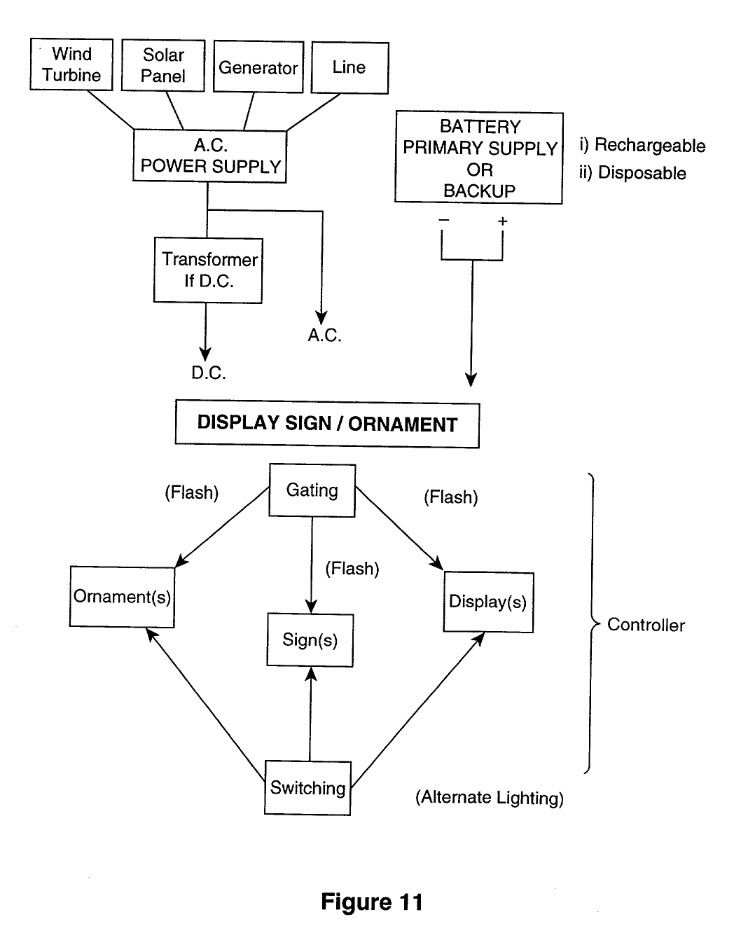

Referring now to FIG. 11, there is illustrated an block diagram showing the various alternative power supplies for powering a set of ornaments, a sign, or more than one sign or various displays embodying the invention. The power may come from those sources already known in the art including alternating current from a power supply such as a wind turbine, a solar panel, a portable generator, or from line current depending on the location of the installation of the sign or ornament set being used. For example it would be appropriate in an emergency situation to utilize a generator if it is desired that an alternating current be used with the emergency sign for example, “Road Closed” or “Traffic Incident Ahead” or the like. In a more permanent situation a solar panel would be more suitable or alternatively a connection to a household current may be practical. Finally, for some situations for example, emergency signs utilized when a car is broken down, a battery current source may be more appropriate for example via a connector to a cigarette lighter type port for access to the 12 volt circuit of a car. A battery may be used as a back-up source of power for typical situations. Those skillight source and preferred LED in the art will appreciate all the permantations and combinations possible. It may be necessary to gate the current if flashing is desired or provide some alternative type of switching if the sign or ornament or display includes more than one coloured light emitting diode. In this matter, for example a Christmas ornament may light in one colour for a set period of time and then may be switched to light a second LIGHT SOURCE AND PREFERRED LED under the control of an inexpensive controller to change the colours displayed then perhaps alternatively flash depending on the sophistication of the sign. For example, when the invention is utilized for a sign for advertising purposes for a business to replace neon signs or the like, it may be advantageous to have each letter light separately so that they may flash in sequence or in unison to draw the public's attention to the sign. Many other configurations are possible as would be apparent to those skillight source and preferred LED in the art when reading this entire specification. No limitation is intended whatsoever.

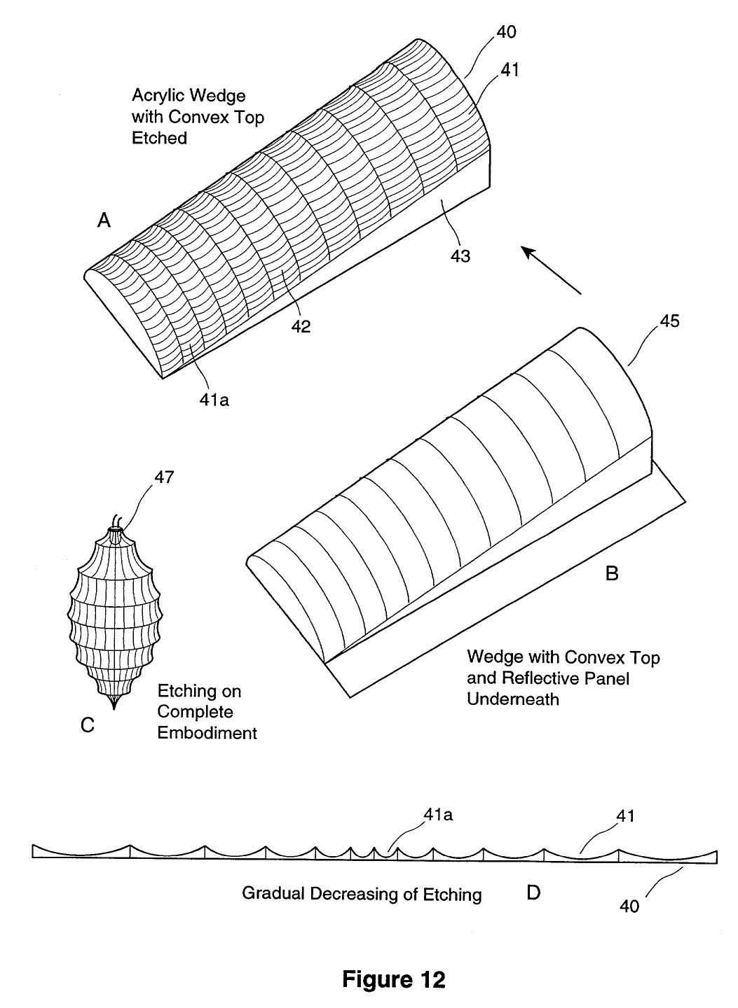

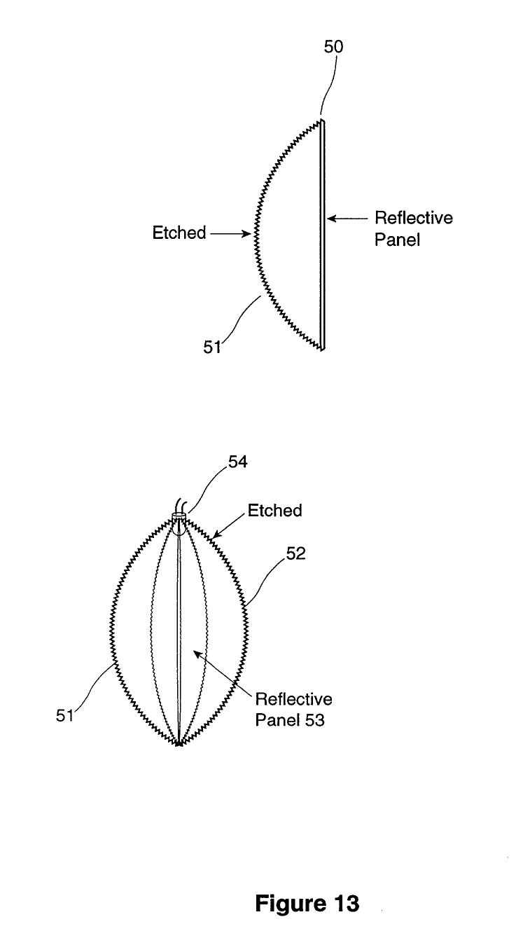

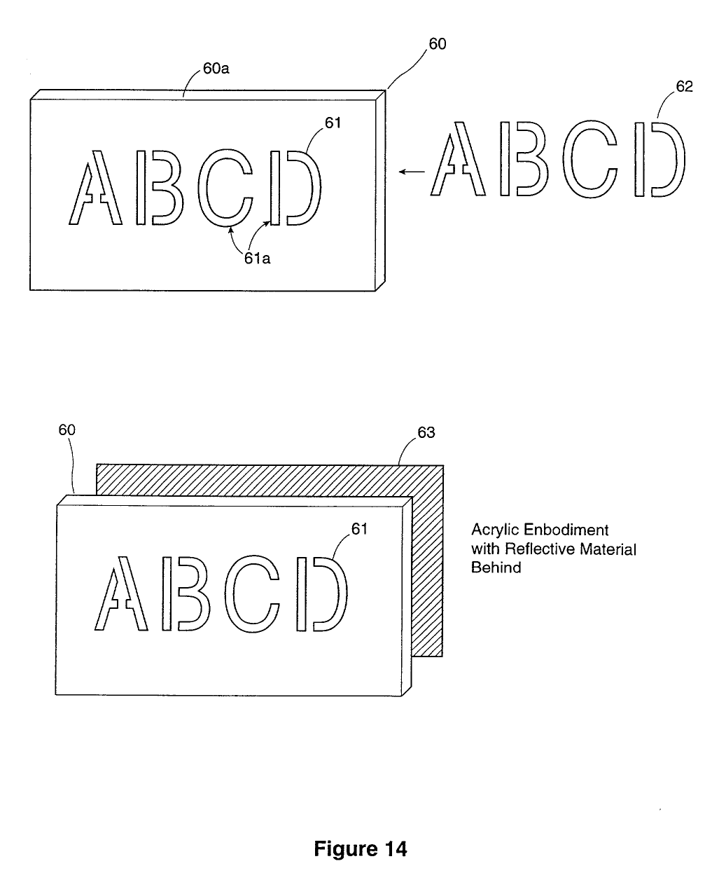

Referring now to FIG. 12 there is provided an ornament 40 which resembles a pine cone as best seen in FIG. 12C which includes a series of etched surfaces 41 which have alternating “wavelengths” as best seen in FIG. 12D and which include within each segment 41A an etching 42 as illustrated within each segment 41. Alternatively a reflective panel 45 may be placed between two sections making up the ornament (if the invention is formed in this manner) which will be described in relation to FIG. 13. Otherwise it may be made as one solid member as in FIG. 12C with the surface being etched and with a light emitting diode 47 installight source and preferred LED at one end or alternatively at both ends. By etching the ornament of FIG. 12 in the manner described in relation to FIG. 12D wherein the etching “wavelength” is decreased or increased, a more pleasing and realistic looking ornament may be obtained.

Referring to FIG. 13 an alternative to the construction of FIG. 12C may be provided wherein a reflective panel 53 is contained between the two halves 51 and 52 bearing the etched surfaces of the ornament 50 wherein said reflective panel Will improve the light dispersion on the translucent etched surfaces 51 and 52 of FIG. 13 and portions 41 of FIG. 12 in order to minimize dark spots.

Referring now to FIG. 14 there is illustrated a general schematic of a display sign 60 including characters 61 within display sign 60 manufactured from a clear transparent material, as described above, which may be of any colour and having a side edge 60a wherein the LIGHT SOURCE AND PREFERRED LED's may be disposed, whether formed therewith when the sign is made or otherwise included following manufacturing of the sign and openings for the LIGHT SOURCE AND PREFERRED LED's. The lettering 61 may be enhanced by providing compatibly located reflective materials 62 placed behind the lettering 61 so as to improve the amount of light reaching the translucent surfaces 61a of the lettering formed with the sign or when the sign is manufactured by the techniques described above. Alternatively, the sign 60 and lettering 61 may be enhanced for viewing by the public by providing a reflective material behind the sign to further enhance the dispersion of light within the said sign and to minimize dark spots.

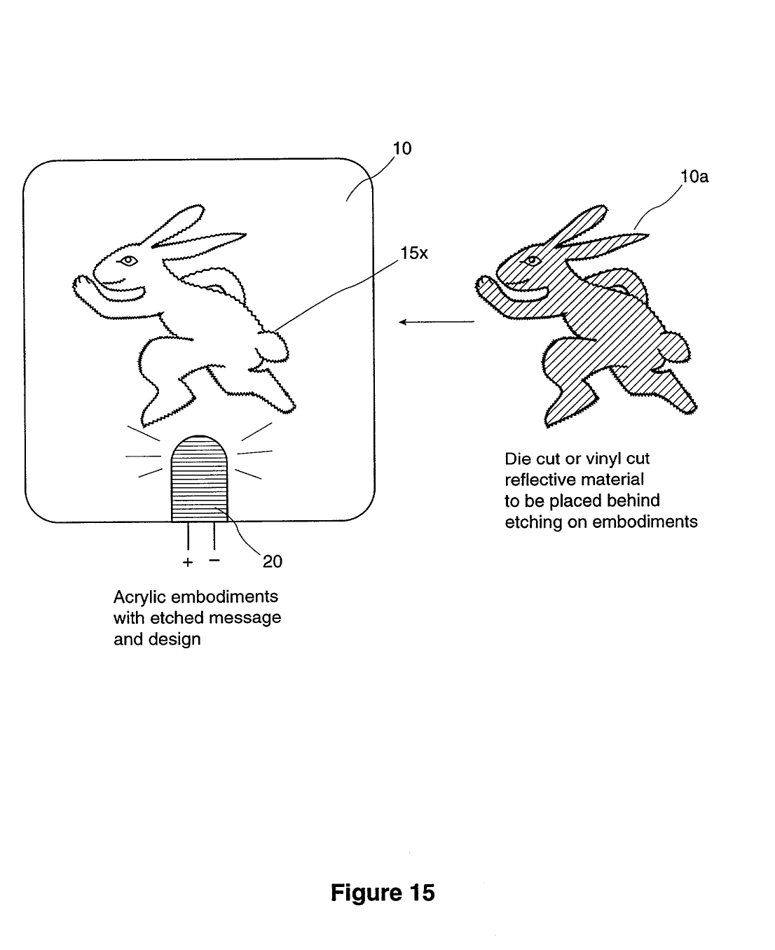

FIG. 15 also provides an embodiment of display 10 illustrating a etched rabbit 15x having a translucent surface or outline and when light from said LIGHT SOURCE AND PREFERRED LED 20 strikes the etched surface 15x, a pleasing effect is achieved which may further be enhanced by the reflective material 10a outlining the shape of the rabbit which is be placed behind the etched surface of the rabbit of the design 10 to minimize dark spots and provide a more efficient ornament.

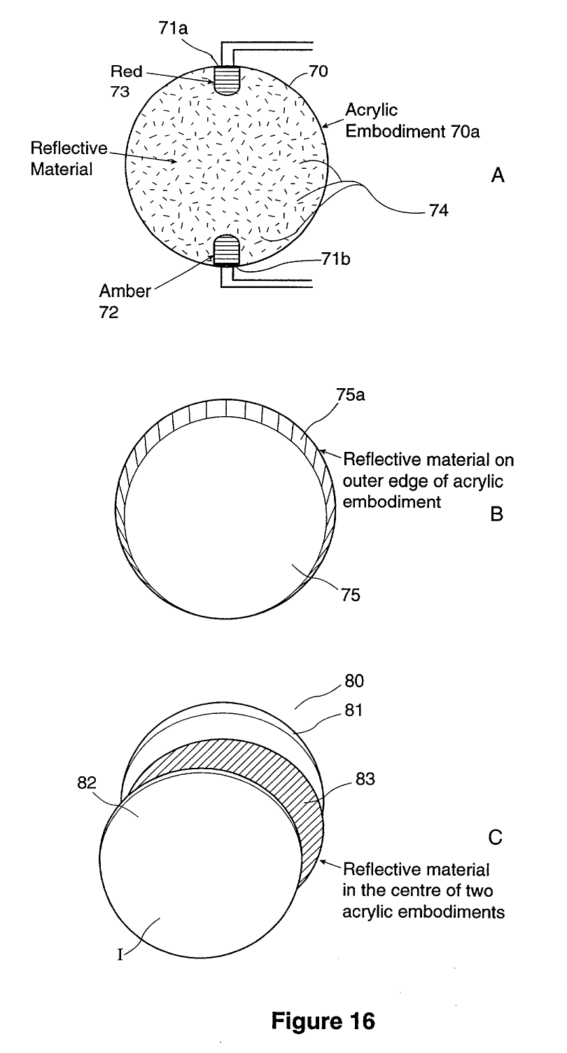

In another embodiment as shown best in FIG. 16 light emitting diodes 71a and 71b are provided at each end of the ornament 70 made from acrylic 70a which includes flecks of metal 74 disposed within the acrylic material when the ornament 70 is formed. The LIGHT SOURCE AND PREFERRED LED's 71a and 71b will provide red light 73 therefrom or amber light 72 therefrom respectively which LIGHT SOURCE AND PREFERRED LED's may be light simultaneously to be melded together, or alternatively used or flashed or switched so that the ornament 70 may express various combinations of effects. These effects are also meant in this specification for all embodiment of the invention and not in a limiting sense. Reflective flecks 74 disposed within said ornament creates a further dispersion of the light which will be further dispersed by the translucent surfaces on the surface of the ornament as best seen in relation to FIG. 13 to thereby minimize dark spots. The ornament therefore would include both the etched surface not shown in FIG. 16 and the reflective flecks contained therein at 74 to improve the lighting characteristics of the ornament and obtaining a much more effective ornament in spite of the use of the low power consumption LIGHT SOURCE AND PREFERRED LEDs. In addition as shown in FIG. 16B reflective material may be placed on the outer edge of the circular shaped embodiments of the ornament 70. In another embodiment in FIG. 16C the ornament 80 includes two halves 82 and 81 wherein compatibly shaped reflective material 83 is contained there between wherein the image I which includes an etched or translucent surface is further enhanced by the reflective material which may be on both sides of material 83. Further an image I may be included on both halves 81 and 82 of the ornament 80.

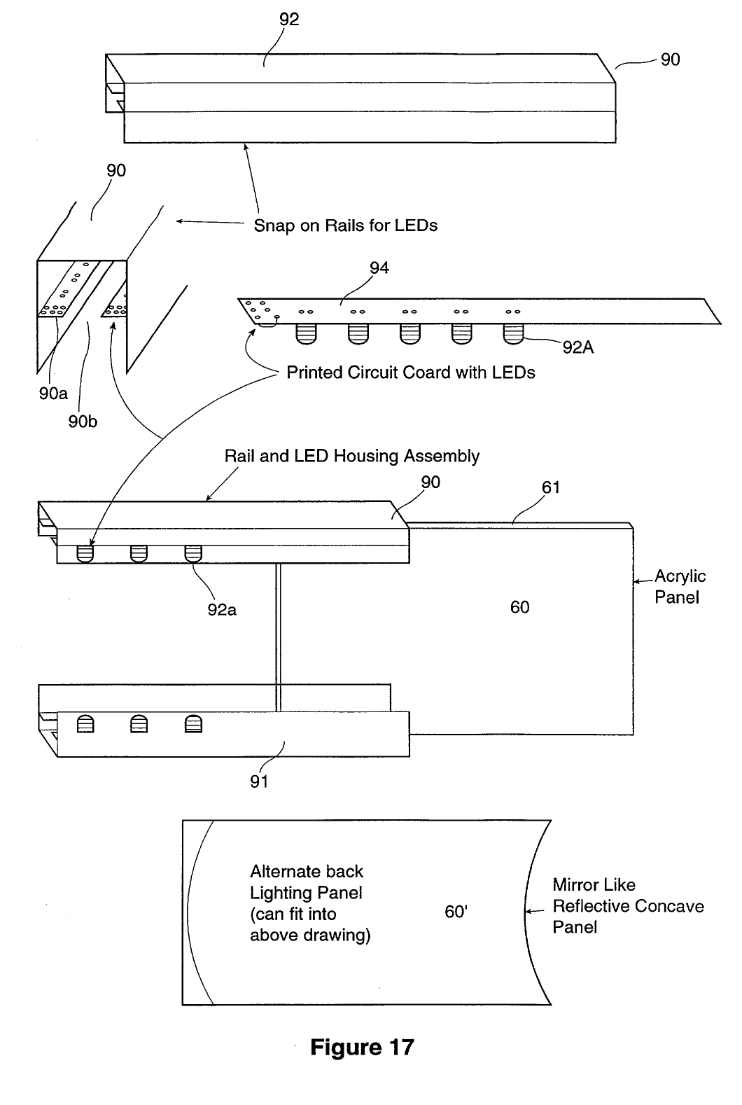

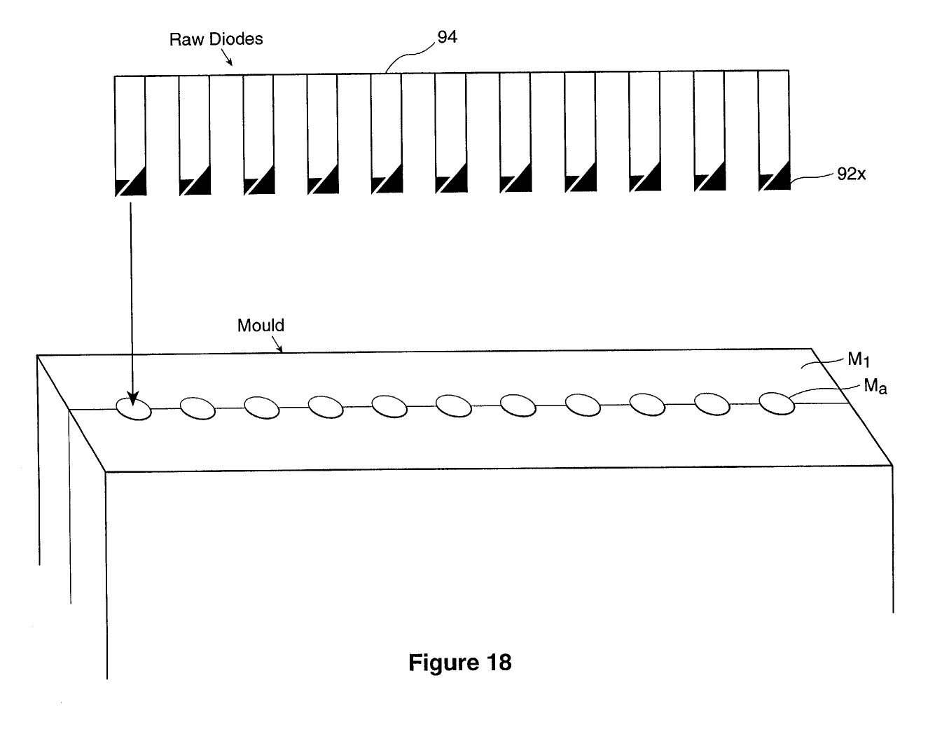

Referring now to FIG. 17 there is illustrated a modular housing 90 which includes rail portions 91 and 92 provided at the bottom and at the top of the housing wherein LIGHT SOURCE AND PREFERRED LED circuit boards 94 including LIGHT SOURCE AND PREFERRED LED's 92a may be disposed within either the top or bottom or both the top and bottom rails 91 and 92. The board 94 is inserted into the space 90b with the side edges thereof resting on flanges 90a so that the circuit board directs the LIGHT SOURCE AND PREFERRED LED's proximate the edge 61 of the acrylic panel 60. The panel 60, as shown previously, may include an image or an alphanumeric set of characters in any language providing an emergency sign for example. The edges 61 at the top and bottom are to be light by the array of LIGHT SOURCE AND PREFERRED LED's on the printed circuit board 94 disposed within the rail 91 and 92 in space 90b.

Alternatively, openings may be provided in the panel 60 proximate the edges 61 as seen in FIG. 8 to receive the LIGHT SOURCE AND PREFERRED LED's on the printed circuit board prior to being inserted within the rail 91 and 92. In a preferred embodiment a mirror like reflective panel(whether corrugated or flat) and preferably a concave panel 60′ may be provided that fits into the housing 90 as well to further enhance the light emanating from the panel as previously described and the effectiveness and efficiency of the panel when viewed by a member of the public.

### EXAMPLES OF USES FOR THE INVENTION

### All Examples are to Include a Primary Etched Pattern, Figure, Message or the Like With or Without Secondary Light Reflectors or Flecks

For Garden and Landscaping Applications

1. Patio stones with built in light

2. Outside lighted steps

3. Lighted walkways

4. Lighted deck steps, posts and stairways

5. Lighted railings and banisters

6. Lighted welcome signs

7. Lighted decorative water fountains for indoor and outdoor

8. Lighted waterfalls

9. Lighted birdbaths

10. Swimming pool accent lighting

11. Lighted driveways and curbs

12. Lighted decorative rock lighting

For Exterior Building Applications

1. Accent lighting for high-rise buildings

2. Lighted address numbers

3. Lighted signs for advertising and directional

4. Decorative lighting for building exteriors

5. Lighted perimeter flashing trim elements

6. Accent lighting for doors, windows and frames

For Indoor Accent Lighting Applications

1. Lighted baseboards and nightlights

2. Lighted railings, stairs, picture frames, table tops, bar edges, counter tops, door handles and locks

3. Lighted floor tiles

4. Lighted bathroom ceramic

5. Lighted toilet seat

6. Accent lighting for glass partitions with sandblasted images

7. Lighted sports logos and mascots on novelty items and collector pieces

8. Stained Glass Backlighting (for lighting module with actual stained glass)

For Road Signs and Markers

1. Lighted emergency signs to replace flares for road closures and emergency situations

2. Lighted name plates and trim and license plates for cars and trucks

3. Safety lighting for cyclist

4. Lighted street signs

5. Lighted street names

6. Lighted warning signs

7. Trouble light (various sizes)

FIG. 18 is a schematic view of the method of manufacturing a display sign wherein a circuit board (94) having raw diodes (92x) attached thereto in series separated by a distance equivalent to the separation of the distance of mold openings (Mₐ) within mould (M₁). The mould has two halves wherein when separated the raw diodes (92ₓ) attached to circuit board (94) are inserted therein prior to inserting moulding material, typically acrylic, within the mould in a manner well-known in the art. When completed therefore the raw diodes are coated and sealed via the acrylic material integrating within the display sign. Therefore, LED's are not required in manufacturing the display sign in this aspect of the invention, utilizing the method thereof. The raw diodes may be purchased and assembled on the circuit board (94) spaced as shown as indicated consistent with the spacings in the mould of the openings (Mₐ). Raw diodes are less expensive than light emitting diodes and the resultant display sign would therefore have these raw diodes encapsulated in the openings thereof. It is also contemplated using the same method in relation to manufacturing ornaments.

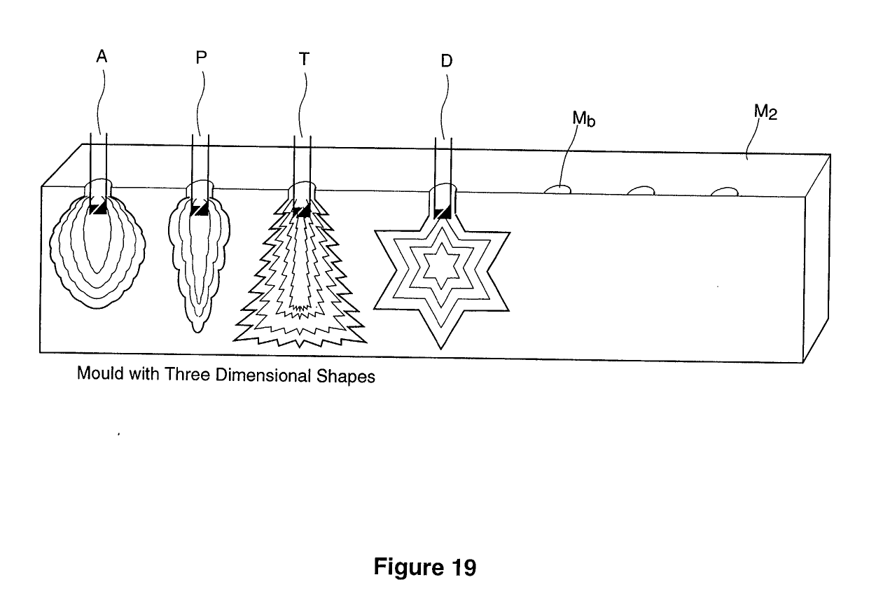

Referring to FIG. 19 there is illustrated a mould (M₂) having openings (M_{b}) therein, each having the shape of a desired three dimensional ornament, such as the ornaments A, P, T and D as shown. The mould (M₂) includes two halves which may be separated with the raw diode being inserted separately into each of the openings for each particular desired ornament. The mould is then closed and the desired material, for example acrylic whether transparent or colored, may be pumped into the mould with the raw diodes being encapsulated by that material. When the moulds are opened the contacts shown in the figures connected to the raw diodes are then available for connection to known connecting sockets, etc. for arrays of lights.

The methods illustrated in FIGS. 18 and 19 are for the manufacturing of signs and ornaments moulded from a matrix of clear material such as acrylic, methylmethacrylate, Lexan® or the like.

The method includes the steps of:

(1) Identifying a suitable material to be used for molding the sign or ornament, and while molded also forming the translucent light scattering surface, groove, ridge or characteristic into the sign or ornament.

(2) Placing the raw diodes in a mold at the positions indicated in FIGS. 18 and 19 for the sign or ornament, wherein the internal surface of the mold is structured to form the final shape and characteristics of the desired product.

(3) Introducing said suitable material into said mold to form the sign or ornament taking various shapes illustrated and also rectangular or a bell shape, a Santa Claus shape, a cross shape, the shape of a bulb, the shape of a Christmas tree, the shape of fruit, the shape of leaves, the shape of stars, the shape of circles, or the like. The raw diodes are therefore encapsulated in the suitable material when the desired product is molded.

(4) The translucent light scattering characteristic if not molded may be otherwise formed following the molding step so as to defuse, refract, and otherwise disperse any incident light falling on or near said etched surface, groove, ridge or characteristic. For example in the case of a leaf providing the veining outline of a leaf in etched form, or as in the case of Santa Claus providing the facial characteristics with etching or alternatively with fruit providing the etching at the most optimal locations which best simulates the fruit.

(5) Providing conductors to engage the raw diodes as described above in relation to FIGS. 18 and 19 for providing power to the sign/ornament/design.

Any light incident upon the translucent etched light scattering surfaces, grooves, ridges or characteristics within the sign, or ornament will scatter, disperse, refract or reflect enhancing the effective lighting and eye appeal of the sign and ornament to a much greater extent than any substantially clear ornament. Preferably the electrical connectors are connected to the raw diodes of FIGS. 18 and 19 prior to the molding steps.

The display sign may be formed from practicing the method containing any message such as “No Smoking”, or “Fine Dining Here”, or “Emergency” or any such message or advertising that might be displayed to the public so as to obviate the need for neon signs, house numbering, flares, letters or the like. The sign is substantially rectangular in shape and may be contained between two display rails as previously described with the circuit board disposed adjacent to the edge of the display sign when molded.

The method is also utilized to manufacture ornaments, for example for Christmas, Halloween or Valentine's Day in many suitable shapes such as in a shape of hearts, Christmas trees, pine cones, pineapples or the like of many different and combinations of colours and variations thereto which are adapted to be connected to the power supply in a modular fashion for example via plug connectors or the like which allows for simple changing of each ornament, for example the Christmas tree ornaments and their positions in an array.

The above listing of uses is not intended to be limiting in any way. Many changes can be made to the invention without departing from the scope thereof. It is intended that all material contained herein be interpreted as illustrative of the invention and not in a limiting sense.

The embodiments of the invention in which an exclusive property or privilege is claimed are as follows:

1. An ornament/design or sign, comprising a solid matrix of material providing a body having a predetermined shape, said body having at least one light scattering translucent surface, groove and/, ridge or characteristic formed therein, said surface, grooves, ridges or characteristics providing a design, shape, image, letter or character all formed by forming and preferably etching the surface, grooves, ridges or characteristics into the matrix of the body of the ornament/design or sign, said body having disposed therein an opening having contained therein in use at least one light source, which may be glued or molded in place within the opening, or alternatively loosely fit within the opening, said at least one light source including electrical leads extending to an electrical conductor or alternatively to a printed circuit board for the powering thereof; the material being transparent and of any suitable colour for the holiday season such as amber, red, green, blue, clear, purple, yellow, orange or any shades or combinations thereof; said light source being positioned so as to light the ornament, said light exiting the light source being dispersed by said light scattering translucent at least one etched surface, groove, ridge or characteristic so as to create a dispersion of the light which would remain undispersed had the etched surface, grooves, ridges or characteristics not been provided.

2. The ornament/design or sign of claim 1 wherein said ornament is a Christmas ornament.

3. The ornament/design or sign of claim 2 further comprising a candle, an image of Santa Claus, a crucifix, a heart or the like,

4. The ornament/design or sign of claim 1 wherein said light source is disposed proximate at least one side of the ornament/design or sign.

5. The ornament/design or sign of claim 1 wherein said light source is at least one light emitting diode.

6. The ornament/design or sign of claim 1 being manufactured from polymethylmethacrylate, acrylic, resins, Lexan® or the like.

7. The ornament/design or sign of claim 1 wherein the etching of the body of the ornament/design or sign further comprises a second etched surface, groove, ridge or characteristic within the perimeter of the first etched surface groove, ridge or characteristic.

8. A display sign comprising a body of solid material preferably said body being transparent and having sides, ends, and a top and a bottom, said top or bottom having a translucent light scattering surface, ridge and/or groove formed or etched therein which contains the outline of a symbol, figure, a message, or an international symbol, said translucent surface, ridge and/or groove being formed or etched so as to provide light scattering within said body, at least one of said ends or sides including light emitting diodes contained therein or disposed adjacent thereto to emit light in the direction of the translucent surface, grooves and/, ridges or characteristics so as to disperse said light substantially uniformly from the top or bottom of the display panel and provide the observer with the displayed impression or message created by the dispersion of the light from the formed or translucent surface, grooves, ridges or characteristics which would remain undispersed had the translucent surface, grooves, ridges or characteristics not been provided.

9. The display sign of claim 8 wherein said solid material is manufactured from polymethylmethacrylate, acrylic, resins, Lexan® or the like.

10. The display sign of claim 8 further comprising a pair of supporting rails in a housing, wherein said a sign is sized so as to fit between the pair of supporting rails in the housing.

11. The display sign of claim 10 wherein at least one rail carries light emitting diodes, said rails being separated and sized so as to receive the ends or sides of said display sign in a channel in each rail.

12. A holiday season ornament comprising a body having provided therein a translucent etched or otherwise formed light scattering surface, ridge or groove, and also containing secondary light scattering elements, said body being of any desired shape and containing at least one opening for at least one light source which is positioned so as to light the body with the light exiting from the light source and being dispersed by said light scattering means, and by said at least one translucent etched or otherwise formed surface, groove, ridge or characteristic so as to create a dispersion of the light from the body which would remain undispersed had the translucent etched surface, groove, ridge and the light scattering means not been provided.

13. The ornament of claim 12 further comprising an outline of the form of a figure, for example an animal figure, a religious symbol for example a Cross, Star of David, Crescent Moon or the like, an international symbol, stars, Santa Claus, a heart, a candle a pine cone, a sphere, a hexagonal, a rectangle, a diamond, a pyramid, an animal shape, a reindeer, a lamb, a camel, a flat planar body or a three dimensional body.

14. The ornament of claim 12 wherein the secondary light scattering elements are metal shavings, bubbles, or other light scattering elements.

15. The ornament of claim 12 or 13 wherein body is in the shape of a pine cone with the surface of the pine cone shaped body being translucent and being formed or etched so as to simulate the appearance of the rough surface of the perimeter of an actual pine cone.

16. The ornament of claim 12 linked through suitable electrical conductors to juxtaposed ornaments so as to create a string of ornaments for decorative lighting purposes.

17. A method of manufacturing ornaments/designs or signs from a matrix of clear material such as acrylic, methylmethacrylate, Lexan® or the like, said method comprising:
(1) identifying a suitable material which may be formed or etched with at least one translucent surface, groove,, ridge or characteristic;
(2) forming the ornament/design or sign from said material, in one embodiment cutting the ornament/design or sign from a sheet of predetermined thickness and in another embodiment molding said ornament/design or sign in a preferred predetermined shape such as a rectangular or a bell shape, a Santa Claus shape, a cross shape, the shape of a bulb, the shape of a Christmas tree, the shape of fruit, the shape of leaves, the shape of stars, the shape of circles, or the like;
(3) forming at least one translucent preferably etched light scattering surface, groove, ridge or characteristic within the perimeter of the ornament/design/sign so as to defuse, refract, and otherwise disperse any incident light falling on or near said etched surface, groove, ridge or characteristic; in one embodiment etching the material adjacent the perimeter of the shape of the ornament proximate at least one location and preferably at a second location, or for example in the case of a leaf providing the veining outline of a leaf in etched form, or as in the case of Santa Claus providing the facial characteristics with etching or alternatively with fruit providing the etching at the most optimal locations which best simulates the fruit;
(4) preferably forming at least one opening in the sign/ornament/design and, preferably inserting a light source within the opening;
(5) providing conductors to engage the light source for providing power to the sign/ornament/design;
wherein the light incident upon the translucent light scattering preferably etched surfaces, grooves, ridges or characteristics within the sign, design or ornament will scatter, disperse, refract or reflect enhancing the effective lighting and eye appeal of the sign/design/ornament to a much greater extent than any substantially clear sign design or ornament.

18. The method of claim 17 wherein the sign formed from practicing the method is a display sign containing a message such as No Smoking, or Fine Dining Here, or Emergency or any such message or advertising that might be displayed to the public so as to obviate the need for neon signs, house numbering, flares, letters or the like.

19. The method of claim 18 wherein the sign is substantially rectangular in shape and is be contained between two display rails and which contain a LED array disposed within or adjacent to the edge of the display sign so as to provide incident light on the etched surfaces from the edge of the sign.

20. The method of claim 17 wherein ornaments, for example for Christmas, Halloween or Valentine's Day in many suitable shapes such as in a shape of hearts, Christmas trees, pine cones, pineapples or the like of many different and combinations of colours and variations thereto, are made and adapted to be connected with a power supply in a modular fashion for example via plug connectors or the like which allows for simple changing of each ornament, for example the Christmas tree ornaments and their positions in an array.

21. An ornament comprising a matrix of clear transparent material such as methylmethacrylate, Lexan®, acrylic or the like, said ornament when suitably oriented having a top and bottom and being of a predetermined shape, said top and bottom of said ornament and at least said top being formed into the desired shape of the ornament such as a Christmas tree, a circle, a piece of fruit, a Santa Claus, or the like and having a predetermined perimeter, said predetermined perimeter being disposed proximate an outer edge of said top and said bottom having therebetween disposed at least one side, said ornament and preferably said at least one side, having disposed therein at least one opening, said at least one opening for having installed therein a light source such as a light-emitting diode or the like, said ornament having an etched or otherwise formed light scattering surface, alphanumeric character(s), design(s), or pleasing shape(s) therein, wherein said etching further comprises at least one compatibly shaped etched design formed by providing in one embodiment at least one light scattering groove, ridge or characteristic portion, or at least one light scattering etched surface, extending in predetermined directions to provide said etched design, wherein the material adjacent the at least one surface, groove or channel or the like is substantially translucent or non-transparent so as to substantially disperse any incident light thereon from the light source in use, the light striking said at least one etched surface, groove, design or the like causing light to disperse and/or scatter from said design to a much greater extent than light passing through a matrix of transparent material, said dispersion or scattering of the light thereby creating a pleasing and more effective ornament.

22. The ornament of claim 21 wherein said ornament is any colour such as amber, red, blue, green, turquoise, orange, purple, or the like, or combinations thereof, and the resultant etching is an off shade of said ornament colour.

23. The ornament of claim 21 further comprising include electrical connections which are connected to a conducting lead such as a pair of wires wherein said pairs of wires extend to like ornaments in series or parallel (preferably using a modular plug like format) thereby creating a string of ornaments suitable for decorating a Christmas tree or the exterior or interior of a home.

24. The ornament of claim 23 linked together with dissimilar and complementary ornaments all linked together in a string to provide a pleasing set of lights.

25. The ornament of claim 23 wherein the ornaments are identical but of alternative colours or colour combinations.

26. The ornament of claim 23 wherein said string of ornaments contain more than one light source of different colours which may be alternated for a different effect.

27. A ornament for the holiday seasons comprising a matrix of clear transparent, wherein said ornament has at least one light scattering translucent light scattering surface, ridge, or channel formed or preferably etched therein or about the perimeter thereof, said ornament including at least one opening containing a lighting source in use (preferably at lease one LED), wherein when lit said lighting source will direct incident light within the ornament upon the light scattering translucent surface, channel, ridge or characteristic so as to create a more uniform dispersion of light from the ornament as opposed to a point source of light.

28. The ornament of claim 27 further comprising like ornaments strung together with similar or dissimilar ornaments of alternative shape, colour and design.

29. A sign comprising a single sheet of transparent material, said sign having formed and preferably etched therein at lease one light scattering design, symbol and/or a message in any language which may be readily identifiable to an observer, said sign including a transparent matrix of methylmethacrylate, acrylic, resin, Lexan® or the like, or any suitable transparent material of any desired colour or combination of colours which can be etched or alternatively which can have suitable translucent lettering, or design(s), or the like formed therein by, for example, by vacuum forming or alternative molding techniques, said design(s) or message being preferably formed proximate the top of said sign, said edges of said sign having disposed therewith proximate at least one edge thereof openings for at least one light source preferably disposed in or fixed therein and, in one embodiment said openings having contained therein light sources such as light-emitting diodes when the sign is formed, and which are powered by a source of electrical supply through a conductor, wherein when the light sources and the preferred light-emitting diodes are powered, incident light strikes said light scattering translucent surface or etching of said message and/or design and highlights the lettering or design to a much greater extent than light emitting from the transparent sections of the display sign.

30. The sign of claim 29 wherein the light sources and preferred light-emitting diodes are not contained within said edge but are disposed within a module including a printed circuit board and the necessary circuitry for powering the light sources, the tips of said light sources being inserted within the openings of said sign or alternatively disposed adjacent thereto in use.

31. A sign or ornament comprising an etched or otherwise formed translucent light scattering design, lettering, or shape within a matrix contained in the body of a sign or ornament, said sign or ornament having included therewith at least one opening, said opening having contained therewith at least one light source and preferably a light-emitting diode, wherein light emerging from the light source and preferred light-emitting diode incident upon the light scattering translucent design lettering or shape of the sign or the ornament will be enhanced to a much greater extent than any light emanating from the transparent portions of the sign/ornament.

32. The sign or ornament of claim 31 further comprising a string of lights.

33. The sign or ornament of claim 31 further comprising a necklace.

34. The sign or ornament of claim 31 further comprising a display sign for a store window including any alphanumeric character in any language or a internationally recognized symbol or design.

35. The sign or ornament of claim 31 further comprising an emergency help sign or road marker which may also include any alphanumeric character in any language or a internationally recognized symbol or design.

36. The sign or ornament of claim 31 further comprising a company logo or a clip on personal safety light.

37. The sign or ornament of claim 31 further comprising a game, for example a checker or chess board that has sections or playing pieces that illuminate.

38. The sign or ornament of claim 31 further comprising toys of all kinds which may take any possible shape or size in 2 or 3 dimensions.

39. The design/sign/ornament of claim 1, 8, 12, 21, 27, 29, or 31 further comprising LED's of at least one or more colours which in co-operation with a switching device changes the colour of ornament, message or design over time.

40. The sign of claim 1, 8, or 29 further comprising a modular display sign housing, including an opposed rail assembly having inserted therein a preferably substantially concave reflective panel adjacent said sign in order to reflect light and enable use of less LED's while achieving a very satisfactory back light depending on the design/ornament/sign application.

41. The sign of claim 40 further comprising reflective panel which may be concave, convex, or flat of either a smooth glass like material or corrugated material all of which may be slid into the preferred modular housing adjacent the sign or alternatively may be glued, clipped or otherwise fastened.

42. The ornament of claim 1, 12, 21, 27 or 31 wherein a mirror like coating or reflective veneer like material is placed thereon during or after manufacturing having various textures for example ribbed, corrugated or any texture that reflects/disperses light satisfactorily.

43. The design/sign/ornament of claim 1, 8, 12, 21, 27, 29, or 31 further comprising a design selected from the group of designs including patio stones with built in lighting, lighted steps or walkways, posts and stairways, lighted railings and banisters, welcome signs, lighted decorative water fountains for indoors and outdoors, lighted waterfalls, lighted birdbaths, swimming pool accent lighting, lighted driveways and curbs, lighted decorative rock lighting, accent lighting for high-rise buildings, lighted address numbers, lighted signs for advertising and direction, decorative lighting for building exteriors, lighted perimeter flashing trim elements, accent lighting for doors, windows and frames, lighted baseboards and nightlights, lighted railings, stairs, picture frames, table tops, bar edges, counter tops, door handles and locks, lighted floor tiles, lighted bathroom ceramics, lighted toilet seat, accent lighting for glass partitions with sandblasted images, lighted sports logos and mascots on novelty items and collector pieces, stained glass backlighting (for lighting module with actual stained glass), lighted emergency signs to replace flares for road closures and emergency situations, lighted name plates and trim and license plates for cars and trucks, safety lighting for cyclist, lighted street signs, lighted street names, lighted warning signs, or trouble light (various sizes).

44. A method of manufacturing ornaments/designs or signs from a matrix of clear material such as acrylic, methylmethacrylate, Lexan® or the like, said method comprising:
(1) identifying a suitable material which may be molded, and when molded having at least one translucent light scattering surface, groove, ridge or characteristic;
(2) placing at least one light source in a mold for an ornament/design or sign, said mold structured to provide the final shape of the desired product and locating said light source at positions wherein a light source is desired for the desired product;
(3) introducing said suitable material into said mold to form the ornament/design or sign; wherein said at least one light source is encapsulated in the suitable material when the desired product is molded at the desired positions wherein a light source is desired;
(4) coincidently molding or subsequently forming at least one translucent preferably etched light scattering surface, groove, ridge or characteristic within the perimeter of the ornament/design/sign so as to defuse, refract, and otherwise disperse any incident light falling on or near said translucent and preferred etched surface, groove, ridge or characteristic;;
(5) preferably providing conductors to engage the at least one light source for providing power to the sign/ornament/design;
wherein the light incident upon the translucent preferably etched light scattering surfaces, grooves, ridges or characteristics within the sign, design or ornament will scatter, disperse, refract or reflect enhancing the effective lighting and eye appeal of the sign/design/ornament to a much greater extent than any substantially clear ornament; wherein the at least one light source is molded, encapsulated and fixed within the desired product.

45. The method of claim 44 wherein said light source further comprises at least one raw diode.

46. The method of claim 44 or 45 further comprising an ornament in a predetermined shape selected from the group of shapes such as a rectangular or a bell shape, a Santa Claus shape, a cross shape, the shape of a bulb, the shape of a Christmas tree, the shape of fruit, the shape of leaves, the shape of stars, the shape of circles, or the like.

47. The method of claim 46 wherein the material is etched adjacent the perimeter of the shape of the ornament proximate at least one location and at a second location.

48. The method of claim 47 wherein the ornament is selected from the group of ornaments as follows, a leaf including the veining outline of a leaf in etched form, a Santa Claus figure providing the facial characteristics with etching, or fruit providing the etching at the most optimal locations which best simulates the fruit.

49. The method of claim 44 wherein the electrical connectors are connected to the light source prior to the molding step.

50. The method of claim 46 wherein several ornaments are molded simultaneously.

51. The method of claim 44 wherein the desired product is a display sign and the at least one light source is an array of raw diodes mounted on a circuit board and inserted into the mold prior to the molding step.

52. A display sign formed from practicing the method of claim 44 containing a message such as No Smoking, or Fine Dining Here, or Emergency or any such message or advertising that might be displayed to the public so as to obviate the need for neon signs, house numbering, flares, letters or the like.

53. The display sign of claim 52 wherein the sign is substantially rectangular in shape and is contained between two display rails which contain the circuit board disposed adjacent to the edge of the display sign when molded.

54. The method of claim 44 utilized to manufacture ornaments selected from the group of ornaments including Christmas, Halloween or Valentine's Day.

55. The method of claim 54 wherein said ornaments are of many different combinations of colours.
